(19) United States
(12) Patent Application Publication
(10) Pub. No.: US 2007/0233820 A1
(43) Pub. Date: Oct. 4, 2007

(54) Dynamic web service configuration broadcasting

(75) Inventor: Manfred Schneider, Nussloch (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/393,016

(22) Filed: Mar. 29, 2006

(51) Int. Cl. G06F 15/177

(52) U.S. Cl. 709/220

(57) ABSTRACT

Methods and apparatuses enable dynamic configuration of a client to access a Web service. A Web service configuration provider can receive a broadcast for a Web service from a client. The client need not be pre-configured with information to access the Web service requested. The Web service configuration provider determines which of available Web service providers can satisfy the request, and provides the configuration information to enable the Web service client to access the Web service provider.

### FIELD

Embodiments of the invention relate to Web services, and more particularly to dynamic web services configuration.

### BACKGROUND

A Web service refers to a software system designed to support interoperable machine-to-machine interaction over a network (local and/or wide). Typically, a Web service defines a set of operations (e.g., a port type) as well as a configuration for using the Web service. The configuration usually includes at least a Web service binding and a Web service endpoint address. Binding refers to the process of associating a protocol and/or data format information with an abstract entity (e.g., a message, operation, port type). An example of a binding is a System Object Access Protocol (SOAP) binding where messages based on extensible markup language (XML) is exchanged over a computer network.

When a Web service client (or, simply, “client”) attempts to call a Web service, the client must comply with the Web service “protocol” by using the port type, the binding, and the endpoint address of the Web service. In traditional systems, a client has a pre-set configuration for each Web service to which the client has access. The client is traditionally unable to request and access a Web service from a Web service provider, unless the client was pre-configured with the configuration information of the service. Requiring the pre-configuration requires the client to know (i.e. store) the configuration of one or more Web services, and the configuration must be manually updated if the configuration parameters and/or needs of the Web service client change. For example, a Web service client may be pre-configured for a particular Web service selected based on cost factors. If the client changes selection criteria to account, for example, for quality of service (QoS), the client may have to be manually updated and configured for a different Web service.

### SUMMARY

Methods and apparatuses enable dynamic configuration of a client to access a Web service. A Web service configuration provider can receive a broadcast for a Web service from a client. The client need not be pre-configured with information to access the Web service requested. The Web service configuration provider determines which of available Web service providers can satisfy the request, and provides configuration information to enable the Web service client to access one or more Web service providers that can satisfy the request. The Web service client selects one of the received configurations, binds the configuration and accesses the selected Web service provider.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of a Web service client coupled to a Web service configuration provider.

FIG. 2 is a block diagram of an embodiment of a Web service client coupled to a Web service configuration provider.

FIG. 3 is a block diagram of an embodiment of a computer device with a Web service client that communicates with a Web service configuration provider.

FIG. 4 is a flow diagram of an embodiment of dynamically configuring a Web service client with configuration of a Web service.

FIG. 5 is a block diagram of an embodiment of a Web service configuration provider.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

Traditional binding of a configuration for a Web service client to access a Web service occurs prior to the Web service client requesting service. This pre-configuration may be referred to as an “early binding,” or a binding that specifies the Web service the client is able to access. As presented herein, a “late binding” can be used to dynamically provide the client with the configuration of a specific Web service. Thus, a client may indicate a port type and details related to accessing a Web service on the port (e.g., operation names, parameter names, parameter types), but simply make a request for service and be presented with the configuration for a Web service that may or may not have been know prior to making the request.

The client broadcasts the Web service configuration request. One or several Web service configuration providers listen to the configuration request and provide Web service configurations in response to receiving the request. The client can then determine which of the provided Web service configurations to use. The client prepares and calls a specific Web service provider to satisfy the request.

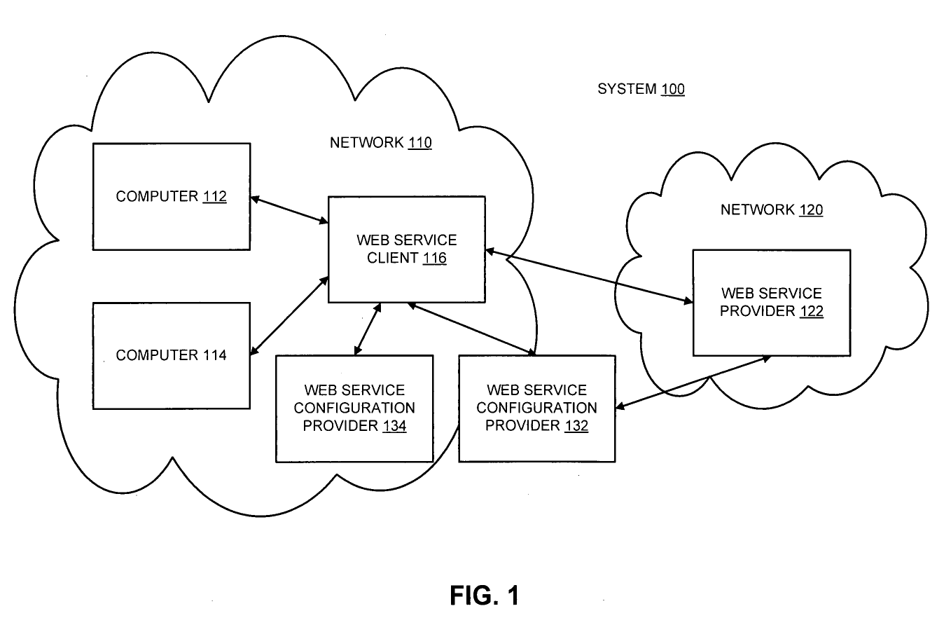

FIG. 1 is a block diagram of an embodiment of a Web service client coupled to a Web service configuration provider. Network 110 includes computers 112-114 and Web service (WS) client 116. Other computers and/or WS clients may be included within network 110. Computers 112-114 are examples of any type of computing device that could interact with a Web service, including laptops, desktops, servers, handheld devices, etc. Computers 112-114 may represent actual hardware devices, as well as virtual machines. A single hardware device may incorporate multiple virtual machines, each of which could be a “computer” such as computer 112. Additionally, a computer can be understood as virtualized from multiple disparate elements of hardware that provide functionality to virtualization software. Thus, one or more of computers 112-114 could be virtual machines that are accessed through a terminal. WS client 116 is an example of a client-side component of a client-server relationship. WS client 116 can include software and/or hardware. WS client 116 provides logic and functionality to interact with a Web service on network 110 and/or a network external to network 110. WS client 116 can exist as a standalone device on network 110, or may be part of a server. WS client 116 may include components on multiple physical devices within network 110, or may be contained in a single device. In one embodiment, one or both of computers 112-114 may include or be associated with a WS client.

Network 110 represents an abstraction of connectivity hardware and software, and may, for example, include one or more local area networks (LANs), virtual LANs (VLANs), virtual private networks (VPNs), etc., or any combination. Network 110 includes one or more WS configuration providers, 132-134, which receive broadcast requests for Web services originating on network 110. WS client 116 can provide a Web service request for one or more computers within network 110. The request may be broadcast across the network, and one or more devices may listen. WS configuration provider 132 may exist within any hardware device of network 110, and may, for example, be a part of a server of network 110. In one embodiment, WS configuration provider 132 is part of a Web service configuration server that includes a traditional configuration server to perform early bindings, and includes WS configuration provider 132 to provide dynamic late bindings. In one embodiment, WS configuration provider 134 exists as a device wholly within network 110. In one embodiment, WS configuration provider 132 exists as an edge device of network 110. An edge device refers to a device that is able to directly access entities external to network 110. A device wholly within network 110 requires an edge device to access entities external to network 110.

WS provider 122 represents a provider that can satisfy a request for a Web service, and may also be understood as the Web service itself. WS provider 122 may also be, or include a WS configuration provider. WS provider 122 provides data and may perform functions to provide information to a requester. As one of innumerable examples, a Web service may include a request for a stock transaction (e.g., buy, sell, quote). In one embodiment, computer 112 requests a Web service, and computer 114 does not. In such an implementation, WS provider 122 provides the service requested by computer 112 for which WS client 116 sends Web service request. WS provider 122 is shown within network 120, which may be a separate network than network 110. For example, network 110 may represent a local network, and network 120 may represent the Internet. In one embodiment, network 120 is part of network 110 (either network 120 is a subpart of network 110, or network 110 is a subpart of network 120). A configuration is required for WS client 116 to access WS 122.

In one embodiment, WS client 116 prepares to call a remote Web service for one or more computers, 112-114, with which WS client 116 is associated. WS client 116 is associated with a computer when it runs on the computer and/or runs on another machine and provides WS access services for a computer. In either case, WS client 116 acts as a client for the computer. WS client 116 determines that the configuration necessary to call the Web service is missing (e.g., WS client 116 does not have the binding and/or endpoint address of WS provider 122). Without the proper configuration information, WS client 116 has insufficient information to determine where or how to call Web service provider 122. In one embodiment, WS client 116 sends one or more broadcast messages on network 110 to request the Web service configuration. A broadcast message is a message sent to all devices within the corresponding broadcast domain. As used herein, a “broadcast domain” is a logical area in a network where any device connected to the network can directly transmit to any other device in the domain without having to go through a routing device, providing they share the same subnet and gateway address. More specifically, a broadcast domain is an area of the network made up of all the networking devices reachable by sending a frame to the data link layer broadcast address. In an alternate embodiment, WS client 116 uses multicasting to deliver the broadcast message to multiple destinations simultaneously, using an efficient strategy to deliver the message over each link of the network 110. As used herein, broadcast will be understood as relating to messages typically considered to be broadcast, as well as relating to messages typically considered to be multicast. The broadcast message may be sent, for example, using User Datagram Protocol (UDP), Transmission Control Protocol (TCP) (i.e., for multicast), or any other protocol that allows exchange of data over a network.

In one embodiment, WS client 116 broadcasts a message that describes the data requested by WS client 116, without indicating how to retrieve the data. Thus, the broadcast defines the requested data but does not provide information/instructions regarding where to look for or retrieve the data. In one embodiment, WS configuration provider 132 listens on network 110 for broadcast messages. As used herein, “listening” for broadcast messages refers to monitoring one or more ports for broadcast messages. For example, WS configuration provider 132 may run a listening daemon or a background process that listens for configuration requests (e.g., on a specific UDP port). The listening daemon could thus be referred to as a configuration daemon. Thus, when WS client 116 broadcasts a request, hosts that listen for the broadcast requests can respond, while non-listening hosts will ignore the broadcast.

In one embodiment, WS configuration provider 132 is, or includes, a platform-independent registry that runs a configuration daemon to listen for broadcast messages. For example, WS configuration provider 132 could be a Universal Description, Discovery, and Integration (UDDI) directory that includes a configuration daemon to listen on a specific UDP port. In another embodiment, WS configuration provider 132 can be any type of repository containing configuration information for different Web services. WS configuration provider 132 can be pre-loaded with WS provider configuration information and WS providers, for example, WS provider 122, can register with WS configuration provider 132. Although described specifically in reference to WS configuration provider 132, the discussion of the WS configuration provider could apply equally well to WS configuration provider 134. There is no requirement that both WS configuration providers 132 and 134 be identical or substantially the same, although they could be. For purposes of simplicity, description with reference to WS configuration providers in general is limited to description of WS configuration provider 132.

When WS configuration provider 132 detects/receives a broadcast message from WS client 116, in one embodiment, WS configuration provider 132 can reply with its identity (e.g. IP address and port number). If WS configuration provider 132 is the only WS configuration provider to reply, then WS client 116 will send a directed request for configuration to WS configuration provider 132 at the IP address and port provided by WS configuration provider 132. In an embodiment where multiple WS configuration providers on network 110 reply to the broadcast request, WS client 116 selects one or more configuration providers to proceed in processing the request. A specific request can be directed to any one or more providers selected by WS client 116.

In one embodiment, WS configuration provider 132 responds to a request for configuration from WS client 116 by providing the configuration (including the endpoint address) of WS provider 122 to WS client 116. After receiving the configuration information, WS client 116 binds configuration to the WS provider 122.

In a simple implementation, WS configuration provider 132 provides configurations for all known Web service providers that provide the requested service. Providing a configuration may be understood as “routing” or “suggesting” a WS client to a particular WS provider. A system may not have any requirements or restrictions on the ability of a WS client to access any one of multiple suggested WS providers. In more sophisticated implementations, WS configuration provider 132 accounts for parameters of the Web service configuration request. (e.g., cost, quality of service (QoS), speed, etc.). In one embodiment, WS configuration provider 132 provides a load balancing mechanism. When one or more Web service providers experience high loads (i.e. high volume of clients attempting to access and/or using the Web service), WS configuration provider 132 detects the high load condition and routes requests to WS providers with more available capacity. WS configuration provider 132 can detect high loads by requesting connection counts or other relevant information and/or statistics from WS providers and comparing the received counts against a threshold value. The threshold value can be different for each WS provider or it can be the same for all WS providers. The WS configuration provider may be designed to stop sending configuration information associated with an overloaded WS provider to a requesting WS client if a threshold value is reached and/or exceeded. When the load is lighter, WS configuration provider 132 may route requests to the WS provider.

The use of multiple WS configuration providers 132-134 can provide a failover mechanism for configuration information requests. For example, WS configuration provider 132 can act as a master WS configuration provider, while WS configuration provider 134 acts as a standby or backup WS configuration provider. As the master WS configuration provider, WS configuration provider 132 has primary responsibility for answering requests from WS client 116. However, if WS configuration provider 132 fails to answer a broadcast request within a certain time period, WS configuration provider 134 or another standby WS configuration provider may reply to the original broadcast request.

In one embodiment, WS configuration provider 132 acts as a broker between WS providers and WS clients. If WS client 116, for example, has a request with parameters indicating reducing costs associated with using a Web service, WS configuration provider 132 can return configurations for Web service providers based on lower prices. For example, if a particular Web service is free while other competing Web services have fees/costs associated with them, WS configuration provider 132 can choose the free Web service and provide the associated configuration to WS client 116. If WS client 116 is concerned with quality of service (QoS) as opposed to cost, WS configuration provider 132 can choose WS providers that can fulfill the client's QoS requirements (e.g. guaranteed response time, etc.).

In addition to serving as a broker, WS configuration provider 132 can be configured to allow other WS configuration providers to subscribe to it. Thus, when processing requests for configurations, WS configuration provider 132 can request configuration information for additional WS providers from other WS configuration providers.

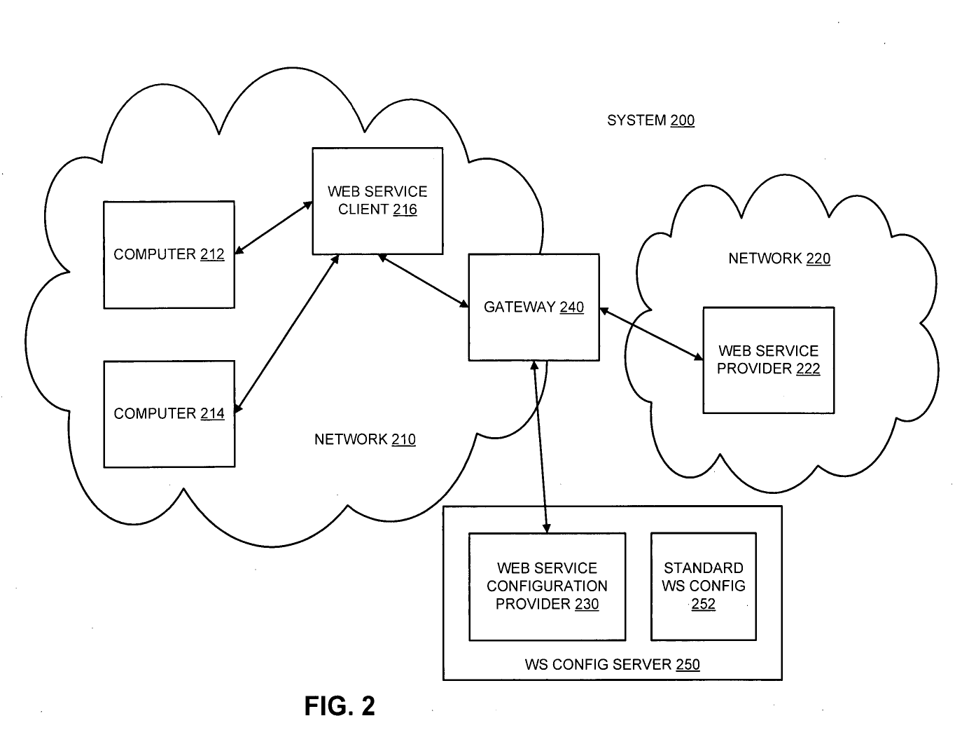

FIG. 2 is a block diagram of an embodiment of a Web service client coupled to a Web service configuration provider. System 200 provides another example implementation of a system having a WS configuration provider to provide dynamic configuration information. System 200 includes networks 210 and 220, which could be similar to networks 110 and 120 of system 100 of FIG. 1. Similarly to FIG. 1, network 210 includes computers 212-214 and WS client 216, and network 220 includes WS provider 222. In system 200, WS configuration provider 230 is not part of network 210, or the network in which WS client 216 broadcasts a Web service configuration request.

WS client 216 broadcasts a request to seek a Web service on behalf of one or more computers 212-214. In one embodiment, WS client 216 has no pre-configuration information, or has no early bindings. In another embodiment, WS client 216 has some early bindings and receives the rest dynamically. Thus, WS client 216 may seek dynamic configuration information for some or all Web services sought. As previously discussed, WS client 216 may prepare to call a WS provider, and know only the kind of Web service being sought, but not the configuration information necessary to call a specific one or more Web services. WS client 216 sends a broadcast message to request the desired configuration information.

In one embodiment, there are no WS configuration providers within network 210 to reply to the broadcast message. Gateway 240 may be configured to listen for broadcast messages. In one embodiment, gateway 240 is configured to listen for broadcast messages on a specified UDP port, for example, a port on which configuration requests are sent. In another embodiment, other known forms of broadcasting and receiving broadcast messages can be used between WS client 216 and gateway 240. When gateway 240 detects a broadcast message, it routes the message to other networks, such as a network that includes WS configuration provider 230. In one embodiment, gateway 240 forwards/routes a received broadcast message directly to a known WS configuration provider, e.g., WS configuration provider 230. Thus, WS configuration provider 230 can receive broadcast messages from a network of which it is not a part, via gateway 240.

Gateway 240 can then proxy the exchange between WS configuration provider 230 and WS client 216. WS configuration 230 replies to the broadcast message by notifying gateway 240 that it is available to receive configuration requests and providing any necessary address information. Gateway 240 routes the address information back to WS client 216, which can send a specific request for configuration information to WS configuration provider 230. Such a request is sent out on network 210 and routed through gateway 240 to be received by WS configuration provider 230.

WS configuration provider 230 includes a repository of configuration information regarding known WS providers. The repository can include configuration information for WS providers that are on the same or different networks as WS configuration provider 230. The repository can be updated dynamically or manually with configuration information for WS providers. Dynamic configuration updating could be accomplished by automated interaction (e.g., registering) between the WS provider and WS configuration provider. When WS configuration provider 230 receives a request for configuration information, it can determine which of known WS providers satisfy the requirements of the request, select one or more WS providers, and provide the configuration information to requesting WS client 216. For example, WS configuration provider 230 may choose WS provider 222 and reply to client 216 with the configuration information for WS provider 222. WS client 216 binds the received configuration information for WS provider 222 to enable access to the Web service of WS provider 222.

In one embodiment, gateway 240 is used even when there is a WS configuration provider within network 210. For example, a WS configuration provider on network 210 may respond to a broadcast message from WS client 216 with erroneous information or it may not respond at all. In such an implementation, gateway 240 may serve as a standby/backup to the primary WS configuration provider and route the broadcast message to other networks when the primary WS configuration provider fails to respond. In another embodiment, gateway 240 may serve as an overflow mechanism. If all of the WS providers on a network (e.g. network 210) are overloaded, gateway 240 can route broadcast messages as overflow to other networks with WS service providers that have available capacity.

In another embodiment, gateway 240 can participate in the brokering process by actively seeking out WS providers (e.g., sending messages, registering/logging service providers) on other networks whose Web services satisfy the requirements of a particular WS client request. Gateway 240 can thus include a WS configuration provider in certain implementations.

In one embodiment, WS configuration provider 230 is part of WS configuration server 250, which provides both standard (i.e., early binding) Web service configurations and dynamic configurations (through WS configuration provider 230). WS configuration server 250 includes standard WS configuration module 252 that provides standard configuration mechanisms for Web services that will be pre-configured.

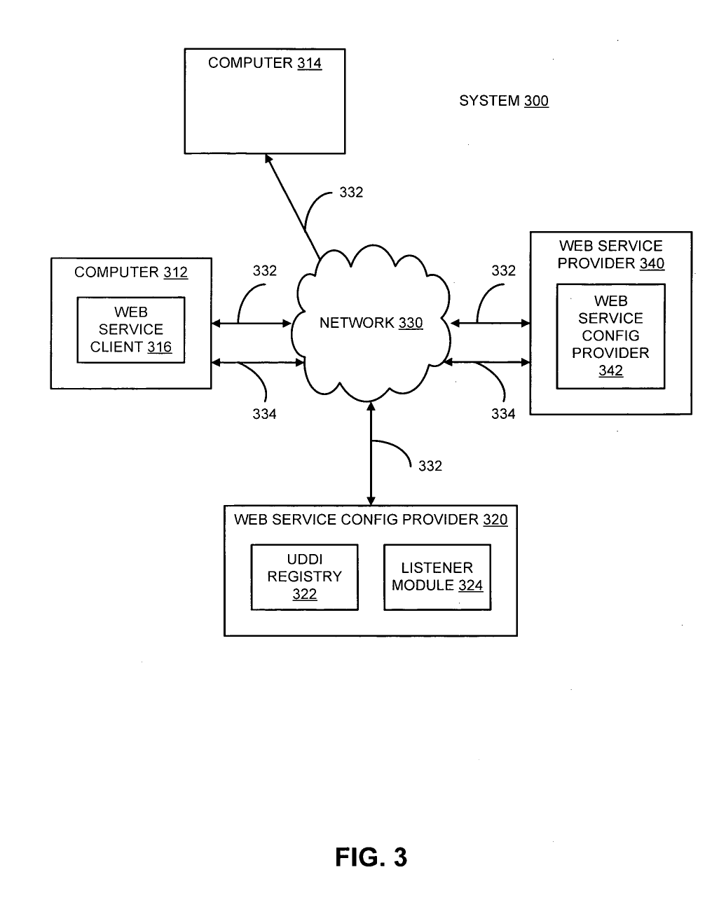

FIG. 3 is a block diagram of an embodiment of a computer device with a Web service client that communicates with a Web service configuration provider. System 300 includes computers 312-314, which are coupled to network 330. In one embodiment, computer 312 includes WS client 316, which provides client-side functionality to enable computer 312 to access a Web service. WS client 316 provides the connectivity functionality of WS clients 116 and/or 216 of FIGS. 1 and 2, respectively. Web service configuration information can be dynamically provided to WS client 316 of computer 312 for Web services that are not pre-configured in WS client 316. Through WS client 316, computer 312 can send out an egress broadcast message 332 on network 330. A listening device may receive broadcast message 332, and provide a response. For example, WS configuration provider 320 and/or WS configuration provider 342 of WS provider 340 may respond to broadcast message 332. The response is received at computer 312 as an ingress broadcast message 332. Computer 314 may also receive broadcast message 314, but if it has no listener, the message will be ignored and no response will be sent.

In one embodiment, WS configuration provider 320 includes UDDI registry 322 and listener module 324. Listener module 324 represents the logic and functionality to monitor for particular messages or message types and respond to them. WS provider 340 may also include WS configuration provider 342, which could include similar elements as WS configuration provider 320.

When a configuration is selected and the binding performed, computer 312 can access WS provider 340 to use its Web service, as previously discussed.

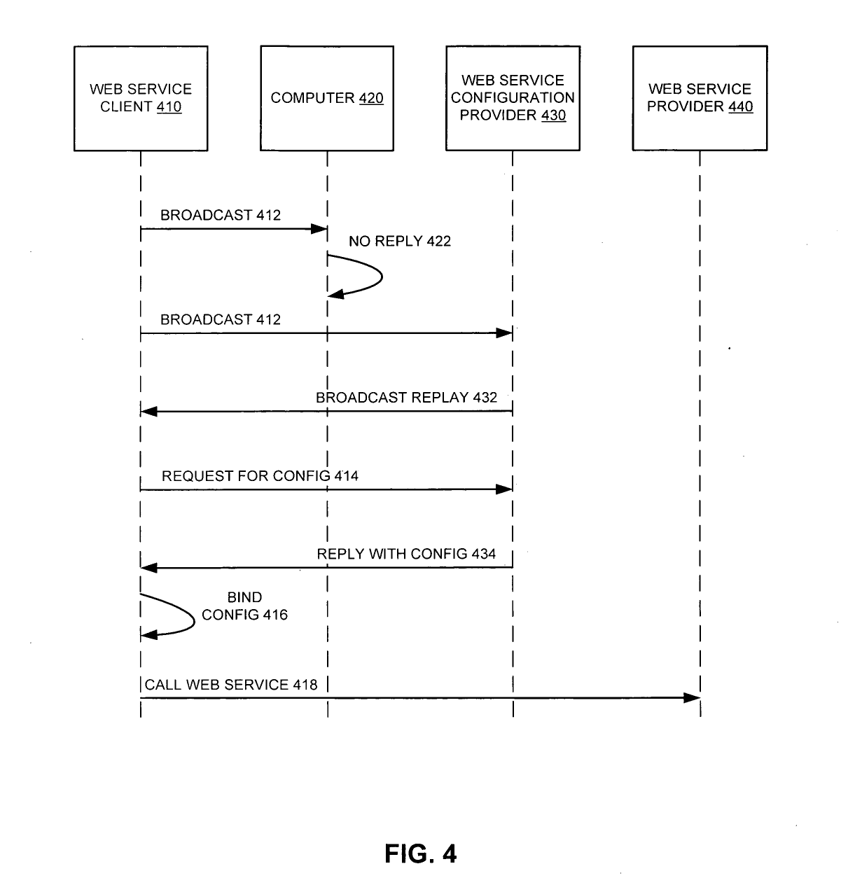

FIG. 4 is a flow diagram of an embodiment of dynamically configuring a Web service client with configuration of a Web service. WS client 410 requests a Web service, but has only service type data and no configuration information to effect a call to a specific Web service provider. Thus, WS client 410 broadcasts a message 412 on the network seeking a WS configuration provider. All hosts in the broadcast group receive the broadcast message 412, including hosts that are not WS configuration providers. For example, computer 420 receives the broadcast message 412, but offers no reply 422 in response to receiving the broadcast message (i.e., it will ignore the broadcast message).

WS configuration provider 430 receives the same broadcast message 412. In one embodiment, WS configuration provider 430 includes an active listening component (e.g., listening daemon) to detect broadcast messages from WS client 410. When WS configuration provider 430 detects the broadcast message 412, it responds with reply 432 to notify WS client 410 of its availability to process a request for configuration. Reply 432 includes addressing information for WS client 410 to use in contacting WS configuration provider 430. WS client 410 receives reply 432 and sends a request for configuration 414 back to WS configuration provider 430. If WS client 410 receives multiple replies to the broadcast messages, WS client will select one or more of the WS configuration providers and send a request for configuration to that WS configuration provider.

WS configuration provider 430 receives a request for configuration 414 and replies by providing the configuration and/or configuration information 434 to WS client 410. WS client 410 binds the received configuration 416 to the Web service. Having bound the configuration to the Web service, WS client 410 is able to direct a call for the Web service 418 to WS provider 440.

In an alternate embodiment, WS client 410 broadcasts message 412 requesting a Web service configuration, to which computer 420 does not reply. In contrast to the embodiment described above, WS configuration provider 430 responds to the broadcast message 412 by sending a Web service configuration 434 back to WS client 410 to enable WS client 410 to access WS provider 440, rather than providing access information to enable WS client 410 to access WS configuration provider 430. Thus, WS client 410 receives a Web service configuration directly in response to the initial broadcast message 412. To enable WS client 410 to communicate with WS provider 440, WS client 410 binds the received configuration to the Web service and calls Web service provider 440. WS client 410 can be understood as binding the configuration in response to receiving the configuration information. The binding could be accomplished upon receiving the configuration information, or at some time after receiving the information and prior to accessing the Web service.

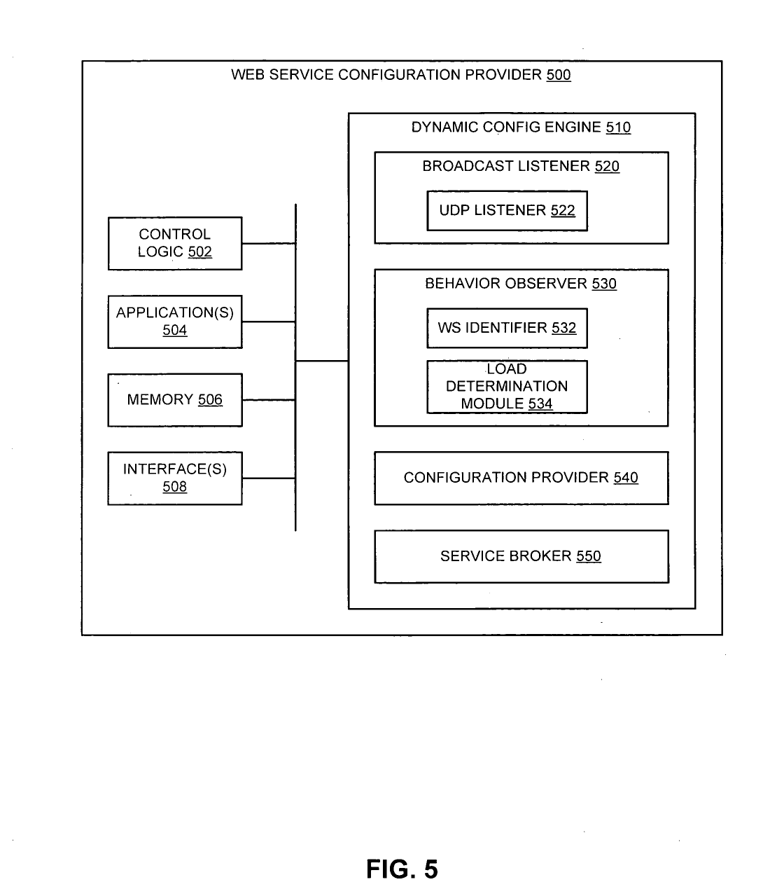

FIG. 5 is a block diagram of an embodiment of a Web service configuration provider. WS configuration provider 500 includes control logic 502, which implements logical functional control to direct operation of WS configuration provider 500, and/or hardware associated with directing operation of WS configuration provider 500. Logic may be hardware logic circuits and/or software routines. In one embodiment, WS configuration provider 500 includes one or more applications 504, which represent code sequence and/or programs that provide instructions to control logic 502. WS configuration provider 500 includes memory 506 and/or access to memory resource 506 for storing data and/or instructions. Memory 506 may include memory local to WS configuration provider 500, as well as, or alternatively, including memory of the host system on which WS configuration provider 500 resides. WS configuration provider 500 also includes one or more interfaces 508, which represent access interfaces to/from (an input/output interface) WS configuration provider 500 with regard to entities (electronic or human) external to WS configuration provider 500. Interfaces 508 include mechanisms through which WS configuration provider 500 can be incorporated into a host application, and may further include interfaces from WS configuration provider 500 to other components or applications of a system in which the host application executes.

WS configuration provider 500 also includes dynamic configuration (config) engine 510, which represents one or more functions that enable WS configuration provider 500 to provide dynamic configuration information. The functions or features include, or are provided by, one or more of broadcast listener 520, behavior observer 530, configuration provider 540, and service broker 550. Each of these modules may further include other modules to provide other functions. As used herein, a module refers to routine, a subsystem, etc., whether implemented in hardware, software, or some combination.

Broadcast listener 520 provides the ability to actively listen to detect and receive broadcast messages. Broadcast listener 520 may include a listening daemon or other monitoring routine. Broadcast listener 520 may specifically include UDP listener 522 to listen on one or more selected UDP ports. Broadcast listener 520 also provides the ability to respond to a received message. The reply may include information on how to access the requested service.

Behavior observer 530 provides the ability to identify a Web service provider that can provide the service requested. Behavior observer 530 includes WS identifier 532 to identify one or more providers of Web services. In one embodiment, all Web service providers known or identified to have the specified service are indicated to the requester. In another embodiment, behavior observer 530 determines that one or more Web service providers offer a better match to the request based on limiting parameters of the request (e.g., cost, QoS). Behavior observer 530 may include load determination module 534 to provide load balancing. Thus, based on the load behavior of Web service providers, behavior observer 530 may selectively not send configuration information for one or more known Web service providers. Behavior of the Web service provider may be considered anything that affects the ability of the Web service provider to provide the service requested, including the limiting parameters.

Configuration provider 540 enables WS configuration provider 500 to send configuration to the requesting client to enable the client to access the Web service.

Service broker 550 enables WS configuration provider 500 to maintain a registry of services that can be indicated to a requesting client. Service broker 550 may work in conjunction with behavior observer 530 to selectively indicate services that meet the criteria of the requester. Service broker 550 also enables WS configuration provider 500 to access another WS configuration provider (not shown), for example, if WS configuration provider 500 does not have a configuration for a WS provider to match a received request. Service broker 550 can forward the request to another WS configuration provider. In addition to contacting another WS configuration provider, service broker 550 enables WS configuration provider 500 to contact a remote service broker, which can provide a service unknown to WS configuration provider 500. Service broker 550 can obtain configuration information for the service from the remote broker, and pass the configuration information to the requesting client.

WS configuration provider 500 may include hardware, software, and/or a combination of these. In a case where WS configuration provider 500 or its constituent components includes software, the software data, instructions, and/or configuration may be provided via an article of manufacture by a machine/electronic device/hardware. An article of manufacture may include a machine readable medium having content to provide instructions, data, etc. The content may result in an electronic device as described herein, performing various operations or executions described. A readable accessible medium includes any mechanism that provides (i.e., stores and/or transmits) information/content in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation. Thus, delivering an electronic device with such code may be understood as providing the article of manufacture with such content described herein. Furthermore, storing code on a database or other memory location and offering the code for download over a communication medium may be understood as providing the article of manufacture with such content described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method for providing access to a Web service, comprising:
receiving a broadcast request for a Web service configuration from a client at a Web service configuration provider;
determining a Web service provider with which to satisfy the request, in response to receiving the broadcast request; and
providing access to a configuration to enable the client to access the Web service provider.

2. The method of claim 1, wherein receiving the broadcast request comprises:
receiving a User Datagram Protocol (UDP) broadcast message.

3. The method of claim 1, wherein receiving the broadcast request at the Web service configuration provider comprises:
receiving at the Web service configuration provider a Universal Description, Discovery, and Integration (UDDI) registry having an active listening module.

4. The method of claim 3, wherein receiving the broadcast request at the Web service configuration provider comprises:
receiving a UDP message at an active listening daemon on the UDDI registry.

5. The method of claim 1, wherein receiving the broadcast request comprises:
receiving the request from a gateway of a network, the gateway to route broadcast requests for Web services.

6. The method of claim 1, wherein determining the Web service provider comprises:
identifying multiple Web service providers capable of satisfying the request; and
selecting a Web service provider from among the identified Web service providers based at least in part on a traffic load on the Web service providers.

7. The method of claim 1, wherein determining the Web service provider comprises:
identifying multiple Web service providers capable of satisfying the request;
selecting a Web service provider from among the identified Web service providers;
determining that the selected Web service provider is unresponsive; and
automatically failing over from the selected Web service provider to a different one of the identified Web service providers.

8. The method of claim 1, wherein determining the Web service provider comprises:
identifying one or more service preferences of the requesting client, the preferences including one or more of a cost of the service, a reliability of the service, or a Service Level Agreement (SLA) with the service;
identifying multiple Web service providers capable of satisfying the request; and
selecting a Web service provider from among the identified Web service providers based at least in part on one or more of the service preferences.

9. An article of manufacture comprising a machine readable medium having content stored thereon to provide instructions to cause a machine to perform operations, including:
monitoring a network port for one or more broadcast messages indicating a request for a Web service;
detecting a broadcast message indicating a request for a Web service for a Web service client, the broadcast message indicating a service type requested;
identifying a Web service provider that provides the service requested; and
replying to the broadcast message to provide configuration information to enable access by the Web service client to the identified Web service provider.

10. The article of manufacture of claim 9, wherein detecting the broadcast message comprises:
detecting a multicast message.

11. The article of manufacture of claim 9, wherein identifying the Web service provider that provides the service requested further comprises:
identifying multiple Web service providers that provide the basic service requested;
identifying one or more service preferences of the requesting client, the preferences including one or more of a cost of the service, a reliability of the service, or a Service Level Agreement (SLA) with the service; and
selecting a Web service provider from among the multiple identified Web service providers based at least in part on one or more of the service preferences.

12. A dynamic Web service configuration provider comprising:
a listener module to detect a broadcast message on a network port indicating a request for a specified type of Web service from a Web service client;
a Web service selector module coupled to the listener module to identify one or more Web service providers that satisfy the broadcast message request, in response to detecting the request; and
a configuration provider coupled to the Web service selector module to transmit a configuration of the identified Web service providers that satisfy the broadcast message request to the Web service client to enable the Web service client to access the requested Web service.

13. The dynamic Web service configuration provider of claim 12, wherein the listener module is to be coupled to a routing device of a network separate from a network to which the dynamic Web service configuration provider belongs; and
the listener module to further receive the broadcast message from the separate network via the routing device.

14. The dynamic Web service configuration provider of claim 12, wherein the Web service selector module identifies a Web service provider in which the dynamic Web service configuration provider is incorporated.

15. The dynamic Web service configuration provider of claim 12, wherein the Web service selector module identifies multiple Web service providers that satisfy the broadcast message request; and
wherein the Web service selector module further comprises:
a load determination module coupled to the Web service selector module, the load determination module to:
determine that a traffic load on one of the identified Web service providers exceeds a threshold of traffic; and
indicate the one Web service provider to the configuration provider to prevent the configuration provider from transmitting configuration information for the one Web service provider.

16. The dynamic Web service configuration provider of claim 12, further comprising:
a broker module coupled to the Web service selector module, to access a remote Web service configuration module to identify a Web service provider not known to the Web service selector module.

17. The dynamic Web service configuration provider of claim 12, further comprising:
a broker module coupled to the Web service selector module, to access a remote Web service broker to identify a Web service provider not known to the Web service selector module.

18. A Web service configuration server comprising:
a Web service pre-configuration provider to provide configuration for a Web service provider, the configuration to be bound at a first Web service client to a Web service prior to the Web service configuration provider receiving a request for the Web service; and
a dynamic Web service configuration provider having a listener module to detect a broadcast message on a network port indicating a request for a specified type of Web service from a second Web service client, a Web service selector module to determine which of multiple available Web service providers satisfies the broadcast message request, in response to detecting the request, and a configuration provider to transmit a configuration of the determined Web service provider, the configuration to be bound to the requested Web service to enable the second Web service client to access the requested Web service.

19. The Web service configuration server of claim 18, wherein the first and second Web service clients are the same Web service client, and
wherein the Web service pre-configuration provider provides configuration for a Web service to be bound prior to an access request by the Web service client, and the dynamic Web service configuration provider provides configuration for a Web service to be bound after an access request by the Web service client.

20. The Web service configuration server of claim 18, wherein the Web service selector module further comprises:
a load determination module coupled to the Web service selector module, the load determination module to:
determine that a traffic load on one of the identified Web service providers exceeds a threshold of traffic; and
indicate the one Web service provider to the configuration provider to prevent the configuration provider from transmitting configuration information for the one Web service provider.
